(19) United States
(12) Patent Application Publication
(10) Pub. No.: US 2024/0105916 A1
(43) Pub. Date: Mar. 28, 2024

(54) COATINGS FOR BATTERY CATHODE MATERIALS

(71) Applicant: UCHICAGO ARGONNE, LLC, Chicago, IL (US)

(72) Inventors: Guiliang Xu, Naperville, IL (US); Yuzi Liu, Naperville, IL (US); Chen Zhao, Woodridge, IL (US); Khalil Amine, Oakbrook, IL (US)

(73) Assignee: UCHICAGO ARGONNE, LLC, Chicago, IL (US)

(21) Appl. No.: 17/955,092

(22) Filed: Sep. 28, 2022

(51) Int. Cl. H01M 4/36; B05D 7/00; H01M 4/131; H01M 4/1391; H01M 4/505; H01M 4/525; H01M 4/62; H01M 10/0569

(52) U.S. Cl. CPC H01M 4/366; B05D 7/54; H01M 4/131; H01M 4/1391; H01M 4/505; H01M 4/525; H01M 4/621; H01M 4/625; H01M 10/0569; H01M 2004/028

(57) ABSTRACT

The present invention provides, in part, electrodes (e.g., cathodes) comprising electroactive materials (e.g., cathode active materials), a primary coating comprising a high entropy metal oxide (HEO), and optionally a secondary coating layer comprising an ionic and electronic conductive polymer, as well as an energy storage device thereof, and methods for making the same.

### STATEMENT OF GOVERNMENT INTEREST

This invention was made with government support under Contract No. DE-AC02-06CH11357 awarded by the U.S. Department of Energy. The government has certain rights in the invention.

### FIELD

The present technology is generally related to electrochemical devices. In particular, this invention relates to anti-corrosion and anti-cracking coatings (e.g., multilayered anti-corrosion and/or anti-cracking coatings) for an electroactive cathode material, as well as the resulting coated cathode materials and batteries comprising such coated cathode materials. The present invention is also related to methods of making the same.

Specifically, the coating described herein comprises a primary coating layer that covers a surface of electroactive cathode particles. The primary coating layer comprises a high-entropy metal oxides (HEO) having a high configurational entropy for electroactive cathode materials, wherein the HEO comprises at least five constituent cations (e.g., at least five constituent cations selected from Li, Ni, Co, Mn, Nb, W, Zr, La, Al, Ti, Cu, Si, V, Mg, Zn, Sn, Ta, Fe, Sb, Y, Cr, Mo, and Sc cations with different weight ratio). In addition, the coating described herein may further comprises a second coating layer comprising a polymer (e.g., a polymer formed through gas-phase reaction). For example, the polymer may be poly(3,4-ethylenedioxythiophene), polypyrrole, polyaniline, or a combination of any two or more thereof.

### BACKGROUND

Cathode materials largely determine the energy density and life span of rechargeable alkaline-ion batteries (e.g., lithium-ion batteries or sodium-ion batteries) and alkaline metal batteries (e.g., lithium metal batteries). Layered transition metal oxides are a class of promising cathode materials for next generation batteries (e.g., next generation batteries for electric vehicle applications) due to their high energy density. One of the effective approaches to further increase the energy density is to extract more alkaline metal ions such as Li+ from the crystal structures of cathodes during charge via increasing either the charge cut-off voltage or the content of cations such as nickel, which however, would induce universal capacity degradation during extended period of cycling. The degradation mechanism has been well studied, which includes: (1) corrosion of electrolytes towards highly oxidized cathodes; (2) particle cracking that can cause the loss of electronic/ionic conduction and can aggravate side reactions with the electrolytes; (3) irreversible phase transition that can induce generation of mechanical strain inside/between the particles and further exacerbate particle cracking. These adverse processes not only cause the continuous loss of capacity during cycling, but also raise serious concerns on the safety of batteries using these cathodes.

Surface coating is an effective approach to mitigate the above noted problems. In particular, the structure, coating uniformity, thickness and/or physical/chemical functionalities of the coating layers are critical to the performance of coated cathodes. Ideally, the coatings should demonstrate excellent anti-corrosion capability against the electrolytes and superior mechanical strength so as to prevent mechanical fatigue of the cathode particles. Moreover, the coatings are expected to be thin and dense layers that homogeneously cover the cathode particles. Previous research using loose oxides particles such as aluminum oxide and titanium oxide would leave bare spots without coatings (FIG. 1). Moreover, these oxides are not resistant to most of the organic battery electrolytes that can easily form HF impurity, and can be gradually etched by HF during cycling. Thus, the above mentioned oxides cannot provide a robust protection for the battery cathode particles. In addition, most of these oxides have low lithium-ion diffusivity (Energy Storage Mater. 2021, 38, 309-328), which can block the diffusion of lithium ions during charge/discharge. Furthermore, the coating layers are mostly physically deposited on the cathode surface, which lack sufficient connection with the cathode materials, and hence can easily break. Thus, there remain a need to develop robust coatings to improve battery performance.

High-entropy materials represent the multi-element metallic systems that can crystallize in a single phase, which includes oxides, carbides, borides, nitrides, and sulfides. Owing to the extremely complex composition of these materials, they often exhibit excellent properties, such as, high lithium-ion conductivity, high fracture toughness, high strength, and excellent anti-corrosion property. However, there are no reports on the formation of coating layers on the surface of battery cathodes using such nanoscale high-entropy materials.

Therefore, there is a need for developing new technologies to generate coated cathode materials (e.g., HEO coated cathode materials).

### SUMMARY

The disclosure is directed to coatings comprising high-entropy metal oxide (TMOₓ) which have high configurational entropy, wherein the coatings can be applied to the electroactive cathode materials of batteries. Differing from traditional oxide coatings which often contain physical mixtures of different oxides particles (FIG. 1) such as aluminum oxide and/or titanium oxide particles, the present invention reforms the conventional oxide coatings to high-entropy metal oxide coatings, in which the TM comprises at least five constituent cations selected from Ni, Co, Mn, Nb, W, Zr, La, Al, Ti, Cu, Si, V, Mg, Zn, Sn, Ta, Fe, Sb, Y, Cr, Mo, and Sc with different weight ratio (FIG. 2). Particularly, this high-entropy metal oxide coating shows advantageous properties such as excellent lithium-ion conductivity, high-temperature anti-corrosion, superior mechanical strength, and/or high oxidation resistance. In addition, the coatings described herein (e.g., the anti-corrosion, and anti-cracking coatings) can significantly alleviate the side reactions with the electrolytes and suppress the particle cracking during extended period of cycling.

In one aspect, provided herein is an electrode for an electrochemical device, comprising:
an electroactive material comprising a surface;
a primary coating layer on the surface of the electroactive material, the primary coating layer comprising a high entropy metal oxide (HEO); and
optionally a secondary coating layer comprising an ionic and electronic conductive polymer;
wherein the secondary coating layer is disposed directly on the surface of the electroactive material, on the primary coating layer, or both directly on the surface of the electroactive material and on the primary coating layer.

In embodiments, the HEO comprises at least five constituent cations selected from Li, Ni, Co, Mn, Nb, W, Zr, La, Al, Ti, Cu, Si, Mg, Zn, Sn, Ta, Fe, Sb, Y, Cr, Mo, V and Sc cations. In embodiments, the HEO comprises at least five constituent cations selected from Ni, Co, Mn, Nb, W, Zr, La, Al, Ti, Cu, Si, Mg, Zn, Sn, Ta, Fe, Sb, Y, Cr, Mo, V, and Sc cations. In embodiments, the HEO comprises at least five constituent metal cations selected from Ni, Co, Mn, Nb, W, Zr, La, Al, Ti, and Ta cations. In embodiments, the HEO comprises at least five constituent metal cations selected from Ni, Co, Mn, Nb, W, Zr, Al, Ti, and Ta cations. In embodiments, the HEO comprises at least five constituent metal cations selected from Ni, Co, Mn, Nb, W, and Zr cations. In embodiments, the cations in HEO are present with different weight percentages.

In embodiments, the primary coating layer is present in a weight percentage from >0 wt. % to about 5 wt. %, based on the weight of the electroactive material. In embodiments, the primary coating has a thickness from about 0.5 nm to about 30 nm.

In some embodiments, the HEO coating layer is crystalline.

In some embodiments, the high-entropy metal oxide coatings comprise well aligned diffusion channels for alkaline ions (e.g., for the extraction and/or insertion of alkaline ions such as lithium ions). In embodiments, the well aligned diffusion channels can improve the rate capability (i.e., fast charging) of a coated cathode material.

In some embodiments, the ionic and electronic conductive polymer comprises poly(3,4-ethylenedioxythiophene), polypyrrole, polyaniline, or a blend of any two or more thereof. In embodiments, the polymer coating can completely cover all the surface of the cathode particles.

In some embodiments, the secondary coating layer is present in a weight percentage from 0 wt. % to about 3 wt. %, based on the weight of the electroactive material. In some embodiments, the secondary coating has a thickness of about 0.5 nm to about 20 nm. In some embodiments, the polymer coating is amorphous.

In some embodiments, the electroactive material comprises: layered lithium nickel manganese cobalt oxide (Li_{1+δ}NiₓMn_{y}Co_{z}O₂, δ≥0, x+y+z=1); layered lithium nickel cobalt aluminum oxide (LiNiₓCo_{y}Al_{z}O₂, x+y+z=1); LiCoO₂; LiNiO₂; LiMnO₂; lithium cobalt oxide (LiCoO₂); spinel lithium nickel manganese oxide (LiNiₓMn₂₋ₓO₄, 0≤x≤2); lithium iron phosphate (LiFePO₄); LiNiPO₄; LiMnₓFe₁₋ₓPO₄ (0≤x≤1); LiCoPO₄; or any combination of any two or more thereof. In some embodiments, the electroactive material comprises layered sodium transition metal oxide (NaTMO₂); wherein TM is Fe, Co, Ni, Mn, Cr, V, Cu, Ti, or a combination of any two or more thereof.

In some embodiments, the electroactive material further comprises one or more dopants selected from the group consisting of Sn, Al, Ti, La, Mg, Zn, Si, Ta, Mo, W, Nb, Fe, Cu, Cr, and Zr.

In some embodiments, the electroactive material is in a form of polycrystalline particles that are micrometer-sized spherical secondary particles comprising nanometer-sized primary particles. In some embodiments, the electroactive material is in a form of single-crystalline particles that do not contain primary particles.

In a related aspect, provided herein is an energy storage device, comprising a cathode comprising the electrode as described herein, an anode, a separator, and an electrolyte.

In some embodiments, the anode comprises lithium metal, sodium metal, graphite, hard carbon, silicon, tin, antimony, phosphorus, transition metal oxide lithium titanate, or a combination of any two or more thereof.

In some embodiments, the cathode and/or the anode comprise one or more of
a current collector;
a conductive carbon material; and
a binder that is sodium carboxymethylcellulose, sodium alginate, poly(acrylic acid), lithiated poly(acrylic acid), sodiated poly(acrylic acid), poly (vinyl alcohol), polyvinyl acetate, poly (ethylene imine), carboxymethyl chitosan, glutaradehyde, B-cyclodextrin polymer, Gum Arabic, PEDOT-PSS, polyacrylic latex, gelatin, polyamido amine, polyvinylidene fluoride, polytetrafluoroethylene, polyethylene, polystyrene, polyethylene oxide, polyimide, styrene butadiene rubber (SBR), polythiophene, polyacetylene, poly(9,9-dioctylfluorene-co-fluorenone), poly(9,9-dioctylfluorene-co-fluorenone-co-methylbenzoic ester), or a combination of any two or more thereof.

In some embodiments, the electrolyte comprises a salt and a solvent comprising ethylene carbonate, propylene carbonate, diethyl carbonate, dimethyl carbonate, ethyl methyl carbonate, tetraethylene glycol, dimethylsulfolane, 1,2-dimethoxyethane, 1,2-diethoxyethane, or a combination of any two or more thereof. In some embodiments, the electrolyte is a solid electrolyte that is a ceramic electrolyte, a polymer electrolyte, a glass electrolyte, or a combination of any two or more thereof. In some embodiments, the electrolytes may be solid-state electrolytes, liquid electrolytes, or a mixture thereof.

In another aspect, provided herein is a method of making an electrode for an energy storage device, comprising:
applying a primary coating layer comprising a high entropy metal oxide (HEO) over an electroactive material;
optionally applying a secondary coating layer comprising a polymer; and
wherein
   the secondary coating layer is disposed directly on the surface of the electroactive material, on the primary coating layer, or both directly on the surface of the electroactive material and on the primary coating layer.

In particular, the method described herein can boost the performance of the cathode materials. The method may comprise applying a primary coating layer comprising high-entropy metal oxide to an electroactive material used in rechargeable batteries such as lithium-ion batteries, sodium-ion batteries, and lithium metal batteries.

In embodiments, the HEO comprises at least five constituent cations selected from the group consisting of Li, Ni, Co, Mn, Nb, W, Zr, La, Al, Ti, Cu, Si, Mg, Zn, Sn, Ta, Fe, Sb, Y, Cr, Mo, V and Sc cations. In embodiments, the cations are present with different weight percentages.

In embodiments, the primary coating layer is formed via a solid-state reaction comprising:
mixing nanoparticles of metal oxides and the electroactive material to form a mixture; and
calcinating the mixture for about 10 h to 20 h at a temperature of about 700° C. to about 900° C.

In some embodiments, the high-entropy metal oxide coating layers are formed through epitaxial growth along the surface lattice of cathode materials, and hence have strong connection with cathode particles.

In some embodiments, the nanoparticles have a particle size of less than 200 nm.

In some embodiments, the secondary coating layer is formed through a non-aqueous coating process. In some embodiments, the secondary coating layer is formed via a gas-phase polymerization between monomers. In some embodiments, the polymerization is conducted at a temperature of about 60° C. to about 150° C. In some embodiments, the polymerization is conducted under a pressure of about 0.1 torr to 1.0 torr.

In some embodiments, the secondary coating layer comprises a polymer such as poly(3,4-ethylenedioxythiophene), polypyrrole, polyaniline, or a combination of two or more thereof.

In some embodiments, the monomers comprise 3,4-ethylenedioxythiophene, pyrrole, or aniline.

In some embodiments, the gas-phase polymerization is conducted in the presence of an oxidant selected from VOCl₃ and SbOCl₃.

### BRIEF DESCRIPTION OF THE DRAWINGS

FIG. 1 depicts schematic illustration of conventional oxides coating that contains multiple loose oxide particles with different composition and crystal structures.

FIG. 2 depicts schematic illustration of high-entropy metal oxide coating layer for layered oxide cathode materials.

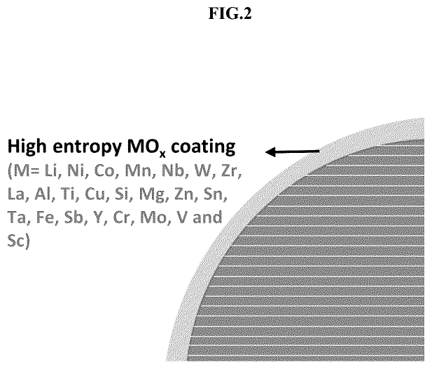

FIG. 3 depicts representative high-angle annular dark-field scanning transmission electron microscopy elemental mapping of a high-entropy NiCoMnZrNbWOₓ coated LiNi_{0.9}Co_{0.05}Mn_{0.05}O₂ cathode.

FIG. 4 depicts representative high resolution transmission electron microscopy image of a high-entropy NiCoMnZrNbWOₓ coated LiNi_{0.9}Co_{0.05}Mn_{0.05}O₂ cathode and the corresponding fast Fourier transform of two selected areas showing the crystal structure of coating layer (area 1) and cathode materials (area 2).

FIG. 5 depicts representative cycling performance of bare LiNi_{0.9}Co_{0.05}Mn_{0.05}O₂ cathode within 2.5-4.3 V at a charge/discharge rate of 1 C (1 hour) and a temperature of 25° C., according to the examples.

FIG. 6 depicts comparison of cycling performance of bare and ZrO₂-coated LiNi_{0.9}Co_{0.05}Mn_{0.05}O₂ cathode within 2.5-4.3 V at a charge/discharge rate of 1 C and a temperature of 25° C., according to the examples.

FIG. 7 depicts comparison of cycling performance of bare, ZrO₂-coated, and high-entropy NiCoMnZrNbWOₓ coated LiNi_{0.9}Co_{0.05}Mn_{0.05}O₂ cathode within 2.5-4.3 V at a charge/discharge rate of 1 C and a temperature of 25° C., according to the examples.

FIG. 8 depicts comparison of cycling performance of bare, ZrO₂-coated, and high-entropy NiCoMnZrNbWOₓ coated LiNi_{0.9}Co_{0.05}Mn_{0.05}O₂ cathode within 2.5-4.3 V at high a charge/discharge rate of 5 C (12 minutes) and a temperature of 25° C., according to the examples.

FIG. 9 depicts comparison of cycling performance of ZrO₂-coated and high-entropy NiCoMnZrNbWOₓ coated LiNi_{0.9}Co_{0.05}Mn_{0.05}O₂ cathode within 2.5-4.3 V at an elevated temperature of 55° C. and a charge/discharge rate of 0.5 C (2 hours) and, according to the examples.

FIG. 10 depicts representative cycling performance of high-entropy NiCoMnZrNbWOₓ coated LiNi_{0.9}Co_{0.05}Mn_{0.05}O₂ cathode within 2.5-4.3 V at a low temperature of 0° C. and a charge/discharge rate of 0.1 C (10 hours) and with a high mass loading of 20 mg cm⁻², according to the examples.

FIG. 11 depicts comparison of cycling performance of ZrO₂-coated and high-entropy NiCoMnZrNbWOₓ coated LiNi_{0.9}Co_{0.05}Mn_{0.05}O₂ cathode within 2.5-4.3 V at a temperature of 55° C. and a charge/discharge rate of 0.1 C (10 hours) and with a high state-of-charge holding at 4.3 V for 72 hours, according to the examples.

FIG. 12 depicts cycling performance of full cell that using high-entropy NiCoMnZrNbWOₓ coated LiNi_{0.9}Co_{0.05}Mn_{0.05}O₂ cathode and graphite anode within 2.8-4.3 V at a charge/discharge rate of C/3 (3 hours) and a temperature of 25° C. with a high mass loading of 13.5 mg cm⁻², according to the examples.

FIG. 13 depicts representative cycle performance of pouch cells using lithium metal anode and high-entropy NiCoMnZrNbWOₓ coated LiNi_{0.9}Co_{0.05}Mn_{0.05}O₂ cathode at a charge/discharge rate of 50 mA g⁻¹ and a temperature of 25° C. within a voltage range of 2.5-4.3V, according to the examples.

### DETAILED DESCRIPTION

The present disclosure provides electrodes (e.g., cathodes) comprising a primary coating layer comprising a high entropy metal oxide, and optionally a secondary coating layer comprising an ionic and electronic conductive polymer, as well as energy storage devices comprising the coated electrodes, and methods of making the same.

As used herein, the term “approximately” or “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term. For example, in certain embodiments, the term “approximately” or “about” refers to a range of values that fall within 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments, and does not pose a limitation on the scope of the claims unless otherwise stated. No language in the specification should be construed as indicating any non-claimed element as essential.

As used herein, the term “surface” (e.g., surface of a particle) may refer to the region of the particle that is nearing the outer most reaches of the particle, and many include the final 0.2 um of the solid material in the particle.

Throughout the description and claims of this specification the word “comprise” and other forms of the word, such as “comprising” and “comprises”, means including but not limited to, and is not intended to exclude, for example, other additives, components, integers, or steps.

“Optional” or “optionally” means that the subsequently described event or circumstance may or may not occur, and that the description includes instances where the event or circumstance occurs and instances where it does not.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

The Electrodes

In one aspect, provided herein is an electrode for an electrochemical device comprising an electroactive material including a surface, a primary coating including a high entropy metal oxide (HEO) (also described as the “the HEO coating”, the “HEO coating layer” or the “HEO layer”), and optionally a secondary coating layer including an ionic and electronic conductive polymer (also described as the “polymer coating”, the “polymer coating layer” or the “polymer layer”).

In some embodiments, the HEO coating layer (e.g., the primary layer) is disposed on a surface of an electroactive material (e.g., a cathode active material such as cathode active material particles). In some embodiments, a surface of an electroactive material is the bare surface of the electroactive material without any other coatings. In some embodiments, a surface of an electroactive material is the surface of a coated electroactive material (e.g., coated with a layer of polymer).

In any embodiments, the coatings described may include a polymer coating layer (e.g., a polymer coating layer as described herein). In some embodiments, the coatings do not include polymer coating layer (e.g., a polymer coating layer as described herein). In some embodiments, the coatings described herein include a polymer coating layer that is disposed directly on the surface of the electroactive material. In further embodiments, the coatings described herein include a polymer coating layer that is disposed on the primary coating layer. In other embodiments, the coatings described herein include a polymer coating layer that is disposed both directly on the surface of the electroactive material and on the primary coating layer.

The Coatings.

In any embodiments herein, provided are coatings (e.g., multilayered coatings) for the cathode electroactive material of rechargeable batteries (e.g., lithium-ion batteries, sodium-ion batteries, or lithium metal batteries). In particular, the coating may include a layer (e.g., a primary layer) of a high-entropy metal oxide (HEO), and optionally a layer (e.g., a secondary layer) of an ionic and electronic conductive polymer.

In any of the embodiments, the electrode described herein may include an HEO coating layer. In embodiments, the HEO coating layer is disposed on a surface of an electroactive material. In some embodiments, a surface of an electroactive material is the bare surface of the electroactive material without any other coatings. In some embodiments, a surface of an electroactive material is the surface of a coated electroactive material (e.g., coated with a layer of polymer).

In some embodiments, the high-entropy metal oxide (HEO) has a high configurational entropy. In some embodiments, the HEO include five or more different constituent cations (e.g., metal cations). In any embodiments, the cations (e.g., the metal cations) may be present at varying mass percentages. In embodiments, the high-entropy metal oxide can be described by formula TMOₓ, wherein TM represents the one or more constituent cations.

In many embodiments, the HEO includes at least five constituent cations selected from Li, Ni, Co, Mn, Nb, W, Zr, La, Al, Ti, Cu, Si, Mg, Zn, Sn, Ta, Fe, Sb, Y, Cr, Mo, V, or Sc cations. In such reference to the metal as a cation, it refers to the metal being a valid oxidation state for that metal. For instance, reference to a cation of lithium is to Li⁺. While reference to a cation of irons may include the +2 or +3 oxidation state cations. In some embodiments, the HEO includes at least five constituent cations selected from Ni, Co, Mn, Nb, W, Zr, La, Al, Ti, Cu, Si, V, Mg, Zn, Sn, Ta, Fe, Sb, Y, Cr, Mo, or Sc cations. In other embodiments, the HEO comprises at least five constituent cations selected from Ni, Co, Mn, Nb, W, Zr, La, Al, Ti, and Ta cations. In some embodiments, the HEO includes at least five constituent cations selected from Ni, Co, Mn, Nb, W, Zr, Al, Ti, and Ta cations. In many embodiments, the HEO includes at least five constituent cations selected from Ni, Co, Mn, Nb, W, or Zr cations. In some embodiments, the TM of formula TMOₓ represents at least six constituent cations selected from Ni, Co, Mn, Nb, W, Zr, La, Al, Ti, Cu, Si, V, Mg, Zn, Sn, Ta, Fe, Sb, Y, Cr, Mo, and Sc. In some embodiments, the TM of formula TMOₓ comprises at least one or more of Ni, Co, Mn, Nb, W, or Zr. In some embodiments, the TM of formula TMOₓ comprises at least one or more of Ni, Co, and Mn. In embodiments, the cations (e.g., the metal cations) are present with different mass percentages.

In some embodiments, the HEO coating layer is present with a weight percentage of ≥0 wt. % to about 5 wt. %, based on the weight of the electroactive material. In some embodiments, the HEO coating layer is present with a weight percentage of about 0.01 wt. % to about 5 wt. %, based on the weight of the electroactive material. In some embodiments, the HEO coating layer is present with a weight percentage of about 0.1 wt. % to about 1 wt. % or about 0.1 wt. % to about 0.5 wt. %, based on the weight of the electroactive material. In some embodiments, the HEO coating layer is present with a weight percentage of about 0.01 wt. %, about 0.05 wt. %, about 0.1 wt. about 0.2 wt. %, about 0.4 wt. %, about 0.6 wt. %, about 0.8 wt. %, about 1.0 wt. %, about 1.2 wt. %, about 1.4 wt. %, about 1.6 wt. %, about 1.8 wt. %, about 2.0 wt. %, about 2.2 wt. %, about 2.4 wt. %, about 2.6 wt. %, about 2.8 wt. %, about 3.0 wt. %, about 3.2 wt. %, about 3.4 wt. %, about 3.6 wt. %, about 3.8 wt. %, about 4.0 wt. %, about 4.2 wt. %, about 4.4 wt. %, about 4.6 wt. %, about 4.8 wt. %, or about 5.0 wt. %, or any value therebetween, based on the weight of the electroactive material.

The HEO coating layer described herein may have a thickness from about 0.5 nm to about 30 nm. In embodiments, the HEO coating layer (e.g., the primary coating layer) described herein has a thickness of about 5 nm to about 20 nm, about 5 nm to about 10 nm, 10 nm to about 15 nm, or about 15 nm to about 20 nm. In some embodiments, the HEO coating layer (e.g., the primary coating layer) described herein has a thickness of about 0.5 nm, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, or about 30 nm, or any value therebetween.

In embodiments, the HEO coating layer described herein is in a form of crystalline. In some embodiments, the HEO coating layer comprises well aligned diffusion channels for extraction and/or insertion of alkaline ions (e.g., lithium ions), which can facilitate the rate capability (i.e., fast charging) of coated cathode materials.

In some embodiments, the electrode described herein (e.g., the coatings for a cathode electroactive material) may include a coating layer (e.g., a secondary layer) comprising a polymer such as an ionic and electronic conductive polymer. In some embodiments, the ionic and electronic conductive polymer is poly(3,4-ethylenedioxythiophene), polypyrrole, polyaniline, or any combination of two or more thereof. In some embodiments, the polymer coating described herein is amorphous.

In embodiments, the coatings described herein comprises a polymer coating layer (e.g., a polymer coating layer as described herein). In embodiments, the coatings described herein does not comprise a polymer coating layer (e.g., a polymer coating layer as described herein). In embodiments, the coatings described herein comprises a polymer coating layer that is disposed directly on the surface of the electroactive material. In embodiments, the coatings described herein comprises a polymer coating layer that is disposed on the primary coating layer. In embodiments, the coatings described herein comprises a polymer coating layer that is disposed both directly on the surface of the electroactive material and on the primary coating layer.

In some embodiments, the polymer coating layer described herein is present with a weight percentage of about 0 wt. % to about 3 wt. %, based on the weight of the electroactive material. This includes a weight percentage of about 0.5 wt. % to about 3 wt. %, about 1.0 wt. % to about 3 wt. %, about 1.5 wt. % to about 3 wt. %, about 2.0 wt. % to about 3 wt. %, or about 2.5 wt. % to about 3 wt. %. In some embodiments, the polymer coating layer is present with a weight percentage of about 0 wt. %, 0.5 wt. %, 1.0 wt. %, 1.5 wt. %, 2.0 wt. %, 2.5 wt. %, 3.0 wt. %, or any value therebetween.

In some embodiments, the polymer coating layer (e.g., the secondary coating layer) described herein has a thickness from about 0.5 nm to about 20 nm. In some embodiments, the polymer coating layer described herein has a thickness of about 0.5 nm, about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, or any value therebetween.

Methods for Making the Coatings

Provided herein are methods for making the coatings (e.g., the coatings as described herein such as the HEO coating layer or the polymer coating layer).

In embodiments, the method described herein comprises formation of a HEO coating layer. For example, the HEO coating layer of the present technology may be formed on a surface of the electroactive material (e.g., the cathode active material) by a sequential processes comprising mixing of the HEO precursors (including mixing the HEO precursors with the cathode active material) and subjecting the obtained products to heat treatment.

In embodiments, suitable precursors for the HEO coating layer include, but are not limited to LiNbWO₆, NiO, NiCoO₂, NiZnFe₄O₄, NiFe₂O₄, NiSc₂ZrO₆, Ni₂O₃, La₂NiO₄, CoO, CoAl₂O₄, CoFe₂O₄, Co₃O₄, La_{0.5}Sr_{0.2}CoO₃, MnO₂, Mn₂O₃, MnO, Mn₃O₄, NbO₂, Nb₂O₅, Nb₁₂WO₃₃, Nb₁₆W₅O₅₅, Nb₁₈W₁₆O₉₃, WO₃, WO₂, SrWO₄, ZrO₂, ZrNb₁₄O₃₇, (ZrO₂)_{0.9}(Sc₂O₃)_{0.1}, (ZrO₂)_{0.94}(Sc₂O₃)_{0.06}, (ZrO₂)_{0.80}(Y₂O₃)_{0.20}, ZrSiO₄, La₂O₃, LaAlO₃, SrLaAlO₄, (LaAlO₃)₃(Sr₂AlTaO₆)₇, La_{0.8}Sr_{0.2}CoO₃, Al₂O₃, Y₃Al₅O₁₂, SrAl₂O₄, Al₂TiO₅, Al_{0.5}Nb_{24.5}O₆₂, TiO, Ti₂O₃, TiSiO₄, TiO₂, TiNb₂O₇, Ti₂Nb₁₀O₂₉, ZnTiO₃, CuO, Cu₂O, CuFe₂O₄, CuZnFe₂O₄, Cu₂Nb₃₄O₈₇, SiO, SiO₂, V₂O₃, V₂O₅, V₂O₄, V₃Nb₁₇O₅₀, MgO, ZnO, ZnFe₂O₄, SnO, SnO₂, SnSb₂O₇, Ta₂O₅, MoO₂, MoNb₁₂O₃₃, Mo₃Nb₁₄O₄₄, Fe₃O₄, FeO, Y₃Fe₅O₁₂, Fe₂O₃, Sb₂O₅, Sb₂O₃, Y₂O₃, Cr₂O₃, CrO₃, MoO₃, MoO₂, and Sc₂O₃.

In some embodiments, the method described herein includes mixing the HEO precursors with the cathode active material. For example, an amount of cathode electroactive material and HEO precursors may be mixed well through mechanical milling. Illustrative mechanical milling methods include but are not limited to roll milling, ball milling, high energy ball milling, planetary milling, stirred ball milling, vibrating milling, and jet milling. In the described method, compressive stress may be mechanically applied by rotating at a speed of about 100 rpm to about 1500 rpm, or about 500 rpm to 1,500 rpm. This includes a rotation speed of about 100 to about 1500 rpm, about 200 to about 1500 rpm, about 400 to about 1500 rpm, about 600 to about 1500 rpm, about 800 to about 1500 rpm, about 1000 to about 1500 rpm, about 1200 to about 1500 rpm, about 1400 to about 1500 rpm. In some embodiments, the rotation speed is about 50 rpm, 100 rpm, 200 rpm, 400 rpm, 600 rpm, 800 rpm, 1000 rpm, 1200 rpm, 1400 rpm, or 1500 rpm, including increments therein.

In embodiments, the method described herein includes subjecting the product from the mixing step (e.g., the well mixed cathode active material and HEO precursors) to heat treatment. In embodiments, the heat treatment is calcination at an elevated temperature. In embodiments, the calcination is carried out under 02 atmosphere.

In embodiments, the calcination may be performed at a temperature of about 500° C. to about 1500° C. In embodiments, the calcination is performed at a temperature of about 700° C. to about 750° C., about 600° C. to about 800° C., or about 700° C. to about 900° C. In some embodiments, the calcination is performed at a temperature of about 500° C., about 550° C., about 600° C., about 650° C., about 700° C., about 750° C., about 800° C., about 850° C., about 900° C., about 950° C., about 1000° C., about 1100° C., about 1200° C., about 1300° C., about 1400° C., about 1500° C., or any value therebetween.

In embodiments, the calcination is performed at a ramping rate of about 0.1 to about 10° C. min⁻¹. In embodiments, the calcination is performed at a ramping rate of about 1.5° C. min⁻¹ to about 2.5° C. min⁻¹, about 1 to about 3° C. min⁻¹, or about 0.5 to about 4° C. min⁻¹. In embodiments, the calcination is performed at a ramping rate of about 0.1, 0.2, 0.4, 0.6, 0.8, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, or 10.0° C. min⁻¹, or any value therebetween.

In embodiments, the calcination is performed with a high temperature holding time of about 5 hours to about 30 hours. In some embodiments, the high temperature holding time is about 8-12 hours, about 5-15 hours, or about 10-20 hours. In some embodiments, the high temperature holding time is about 5, 6, 7, 8, 9, 10, 11, 12, 13, 14, 15, 16, 17, 18, 19, 20, 21, 22, 23, 24, 25, 26, 27, 28, 29, or 30 hours, or any value therebetween.

In embodiments, the method described herein comprises formation of a polymer coating layer as described herein. In some embodiments, the polymer coating layer of the present technology may be formed by polymerization of monomers in the presence of initiator via a gas-phase polymerization process.

In some embodiments, the gas-phase polymerization is conducted under a temperature of about 20° C. to about 150° C. or about 60° C. to about 150° C. In some embodiments, the gas-phase polymerization is conducted under a temperature of about 20° C., about 30° C., about 40° C., about 50° C., about 60° C., about 70° C., about 80° C., about 90° C., about 100° C., about 110° C., about 120, about 130, about 140, or about 150° C., or any value therebetween.

In some embodiments, the gas-phase polymerization is conducted under a pressure of about 0.1 torr to about 1.0 torr. In some embodiments, the gas-phase polymerization is conducted under a pressure of about 0.1 torr, about 0.2 tor, about 0.3 torr, about 0.4 torr, about 0.5 torr, about 0.6 torr, about 0.7 torr, about 0.8 torr, about 0.9 torr, or about 1.0 torr, or any value therebetween.

In some embodiments, the gas-phase polymerization is conducted in a reaction container with rotation. In some embodiments, the reaction container has a rotation speed of about 20 rpm to about 200 rpm. In some embodiments, the reaction container has a rotation speed of about 20 rpm, about 30 rpm, about 40 rpm, about 50 rpm, about 60 rpm, about 70 rpm, about 80 rpm, about 90 rpm, about 100 rpm, about 110 rpm, about 120 rpm, about 130 rpm, about 140 rpm, about 150 rpm, about 160 rpm, about 170 rpm, about 180 rpm, about 190 rpm, or about 200 rpm, or any value therebetween.

In some embodiments, the gas-phase polymerization for forming the polymer coating (e.g., the coating time) is performed for about 5 minutes to about 100 minutes. In some embodiments, the coating time is about 5 minutes, about 10 minutes, about 15 minutes, about 20 minutes, about 25 minutes, about 30 minutes, about 35 minutes, about 40 minutes, about 45 minutes, about 50 minutes, about 55 minutes, about 60 minutes, about 65 minutes, about 70 minutes, about 75 minutes, about 80 minutes, about 85 minutes, about 90 minutes, about 95 minutes, or about 100 minutes, or any value therebetween.

In embodiments, the electrode comprising coatings as described herein is a cathode.

In embodiments, the cathode may include one or more of a cathode electroactive material, a current collector, a conductive carbon material, and a binder.

Illustrative cathode electroactive material includes but is not limited to, a layered lithium nickel manganese cobalt oxide (Li_{1+δ}NiₓMn_{y}Co_{z}O₂, δ≥0, x+y+z=1); layered lithium nickel cobalt aluminum oxide (LiNiₓCo_{y}Al_{z}O₂, x+y+z=1); LiCoO₂; LiNiO₂; LiMnO₂; lithium cobalt oxide (LiCoO₂); spinel lithium nickel manganese oxide (LiNiₓMn₂₋ₓO₄, 0≤x≤2); lithium iron phosphate (LiFePO₄); LiNiPO₄; LiMnₓFe₁₋ₓPO₄ (0≤x≤1); LiCoPO₄; layered sodium transition metal (TM) oxide cathodes (NaTMO₂), wherein TM is selected from Fe, Co, Ni, Mn, Cr, V, Cu, Ti, and a combination of any two or more thereof. In some embodiments, the cathode active material further comprises one or more dopants selected from the group consisting of Sn, Al, Ti, La, Mg, Zn, Si, Ta, Mo, W, Nb, Fe, Cu, Cr, and Zr.

In some embodiments, the cathode active material is in a form of cathode particles (cathode active material particles). In embodiments, the cathode particles are polycrystalline particles. In embodiments, the polycrystalline particles comprise micrometer-sized secondary spherical particles. In embodiments, the secondary spherical particles further comprise nanometer-sized primary particles. In embodiments, the secondary particles have a particle size of about 5 um to about 20 um. In some embodiments, the secondary particles have a particle size of about 5 um, about 6 um, about 7 um, about 8 um, about 9 um, about 10 um, about 11 um, about 12 um, about 13 um, about 14 um, about 15 um, about 16 um, about 17 um, about 18 um, about 19 um, or about 20 um, or any value therebetween. In embodiments, the primary particles have a particle size of about 100 nm to about 900 nm or about 100 nm to about 200 nm. In some embodiments, the primary particles have a particle size of about 100 nm, about 200 nm, about 300 nm, about 400 nm, about 500 nm, about 600 nm, about 700 nm, about 800 nm, or about 900 nm, or any value therebetween.

In embodiments, the cathode particles are single-crystalline particles. In embodiments, the single-crystalline particles are micrometer-sized single-crystalline particles without the primary particles. In embodiments, the single-crystalline particles have a particle size of about 1 um to about 10 um. In some embodiments, the single-crystalline particles have a particle size of about 1 um, about 2 um, about 3 um, about 4 um, about 5 um, about 6 um, about 7 um, about 8 um, about 9 um, or about 10 um, or any value therebetween.

The Energy Storage Device

In another aspect, provided herein is an electrochemical energy storage device comprising an electrode (e.g., a cathode) according to any aspects and/or embodiments described herein. The electrochemical device may further include an anode, an electrolyte, and/or a separator.

In embodiments, the anode may include one or more of an anode electroactive material, a current collector, a conductive carbon material, and a binder.

In embodiments, the anode comprises an anode active material. In embodiments, the anode material includes one or more of lithium metal, sodium metal, graphite, hard carbon, transition metal oxides, silicon, tin, phosphorus, antimony, and lithium titanate.

In embodiments, the cathode and/or the anode of an electrochemical energy storage device described herein comprise a conductive carbon materials. Illustrative conductive carbon material includes, but is not limited to, microporous carbon, mesoporous carbon, mesoporous microbeads, graphite, expandable graphite, carbon black, or carbon nanotubes, or any combination thereof. Commercial examples of carbon black include, but are not limited to, Super-P®, Black Pearls® 2000, Denka Black®, Vulcan® XC72R, Ketjenblack®, and any combination of two or more thereof.

In embodiments, the cathode and/or the anode of an electrochemical energy storage device described herein comprise a binder. Illustrative binders include, but are not limited to, polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, polythiophene, polyacetylene, poly(9,9-dioctylfluorene-co-fluorenone), poly(9,9-dioctylfluorene-co-fluorenone-co-methylbenzoic ester), and a combination of any two or more thereof. In embodiments, the binder is a copolymer of any two or more monomers selected from the monomers used to form polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, polythiophene, polyacetylene, poly(9,9-dioctylfluorene-co-fluorenone), and poly(9,9-dioctylfluorene-co-fluorenone-co-methylbenzoic ester).

In some embodiments, the binder is an electrically conductive polymer. Exemplary electrically conductive polymers include, but are not limited to, polythiophene, polyacetylene, poly(9,9-dioctylfluorene-co-fluorenone), poly(9,9-dioctylfluorene-co-fluorenone-co-methylbenzoic ester), and a combination of any two or more thereof. In some embodiments, the binder is a copolymer of any two or more monomers selected from the monomers used to form polythiophene, polyacetylene, poly(9,9-dioctylfluorene-co-fluorenone), and poly(9,9-dioctylfluorene-co-fluorenone-co-methylbenzoic ester).

In embodiments, the binder may be present in the electrode in an amount of about 0.1 wt. % to about 10 wt. %, about 0.1 wt. % to about 5 wt. %, or about 5 wt. % to about 10 wt. %. In some embodiments, the binder is present in the electrode in an amount of about 2 wt. % to about 20 wt. %. In embodiments, the binder is present in the electrode in an amount of about 0.1 wt. %, about 1 wt. %, about 2 wt. %, about 4 wt. %, about 6 wt. %, about 8 wt. %, about 10 wt. %, about 15 wt. %, or about 20 wt. %, or any value therebetween.

In embodiments, the cathode and/or the anode of an energy storage device described herein comprise a separator. Illustrative separators include, but are not limited to, Celgard® 2325, Celgard® 2400, Celgard® 3501, and a glass fiber separator.

In some embodiments, the energy storage device described herein is a lithium-ion battery or a lithium metal battery. In some embodiments, the energy storage device described herein comprises an electrolyte. In embodiments, the electrolyte may comprise a lithium salt and a solvent. In embodiments, a lithium salt may be dissolved in an organic solvent to form the electrolyte that is a non-aqueous liquid electrolyte solution.

A non-limiting list of lithium salts includes LiPF LiClO, LiAlCl, LiI, LiBr, LiSCN, LiBF LiB(CHs), LiASF, LiCFSO, LiN(CFSO), and a combination of any two or more thereof. The lithium salts described herein may be dissolved in a variety of organic solvents, including but not limited to alkyl carbonates, such as cyclic carbonates (e.g., ethylene carbonate (EC), propylene carbonate (PC), and butylene carbonate (BC)), acyclic carbonates (e.g., dimethyl carbonate (DMC) and diethyl carbonate (DEC), ethylmethylcarbonate (EMC)); aliphatic carboxylic esters (e.g., methyl formate, methyl acetate, and methyl propionate); Y-lactones (e.g., Y-butyrolactone and Y-Valerolactone); chain structure ethers (e.g., 1,2-dimethoxyethane and 1-2-diethoxyethane, ethoxymethoxyethane); cyclic ethers (e.g., tetrahydrofuran and 2-methyltetrahydrofuran); and a combination of two or more thereof.

The lithium salt may be present in the electrolyte at a concentration of about 0.01 M to about 3.0 M. In some embodiments, the lithium salt is present in the electrolyte at a concentration of about 0.5 M to about 3.0 M, including about 0.5 M to about 2.0 M, about 0.5 M to about 1.5 M, about 1.0 M to about 3.0 M, or about 1.0 M to about 2.0 M. In some embodiments, the lithium salt is present in the electrolyte at a concentration of about 0.01 M, about 0.05 M, about 0.1 M, about 0.5 M, about 1.0 M, about 1.5 M, about 2.0 M, about 2.5 M, or about 3.0 M, or any value therebetween.

In some embodiments, the energy storage device described herein is a sodium-ion battery or a sodium metal battery. In some embodiments, the energy storage device described herein comprises an electrolyte. The electrolyte may include a sodium salt and a solvent. In embodiments, the sodium salt may be NaClO₄, NaPF₆, NaAsF₆, NaBF₄, NaCF₃SO₃ or NaN(SO₂CF₃), or any combination of two or more thereof. In embodiments, the solvent is an organic solvent comprising at least one of ethylene carbonate, propylene carbonate, diethyl carbonate, dimethyl carbonate, ethyl methyl carbonate, tetraethylene glycol, dimethylsulfolane, 1,2-dimethoxyethane, and 1,2-diethoxyethane.

In embodiments, the sodium salt may be present in the electrolyte at a concentration of about 0.01 M to about 3.0 M. In some embodiments, the sodium salt is present in the electrolyte at a concentration of about 0.5 M to about 3.0 M, including about 0.5 M to about 2.0 M, about 0.5 M to about 1.5 M, about 1.0 M to about 3.0 M, or about 1.0 M to about 2.0 M. In some embodiments, the salt is present in the electrolyte at a concentration of about 0.01 M, about 0.05 M, about 0.1 M, about 0.5 M, about 1.0 M, about 1.5 M, about 2.0 M, about 2.5 M, or about 3.0 M, or any value therebetween.

In some embodiments, the electrolyte according to any embodiments described herein may further include an electrolyte additive. Illustrative electrolyte additives include, but are not limited to, vinylene carbonate, fluorinated ethylene carbonated, cyclic disulfonic ester methylene methanedisulfonate (MMDS), lithium bis(oxolate)borate, ethylene sulfite, ethylene sulfate, trimethylene sulfite, 1,3-butylene glycol sulfite, tris(trimethylsilyl) phosphate (TMSP) and tris(trimethylsilyl)borate (TMSB), and a combination of any two or more thereof. The electrolyte additive may be present in the electrolyte in an amount of about 1% to about 10% by weight or by volume. This includes an amount of about 1% to about 8% by weight or by volume, about 1% to about 6% by weight or by volume, about 1% to about 4% by weight or by volume, or about 1% to about 3% by weight or by volume. In some embodiments, the electrolyte additive is present in the electrolyte in an amount of about 1%, about 2%, about 3%, about 4%, about 5%, about 6%, about 7%, about 8%, about 9%, or about 10% by weight or by volume.

In some embodiments, the energy storage device is a solid-state battery comprising a solid electrolyte. The solid electrolyte may comprise one or more of a polymer-based electrolyte, a glass-based solid electrolyte, or a crystalline ceramic electrolyte (e.g., a halide based, a oxide-based or a sulfide-based electrolyte). In particular, the high-entropy coating layer (e.g., the HEO coating layer) can significantly suppress the side reactions between oxidized cathodes and solid electrolytes, and thus stabilize the interface and improve the cycling stability.

### EXAMPLES

### Example 1. Synthesis of Bare Cathode Materials without Coating

Layered transition metal oxide (LiNi_{0.9}Co_{0.05}Mn_{0.05}O₂, denoted as NCM90) was used as an example to demonstrate the effect of HEO coating in improving the cycling stability under various working conditions.

Layered oxide cathodes are very promising as cathodes for lithium-ion batteries and lithium metal batteries because of their high specific capacity (>200 mAh g⁻¹). However, without proper protection, they tend to undergo severe capacity fading upon cycling, particularly with increased content of nickel in NCM or increased charge cut-off voltage (e.g., 4.3 V vs. Li/Li⁺).

Synthesis of NCM90 was performed through solid-state reaction between Ni_{0.9}Co_{0.05}Mn_{0.05}(OH)₂ precursor and LiOH·H₂O. Briefly, Ni_{0.9}Co_{0.05}Mn_{0.05}(OH)₂ precursor was synthesized by a co-precipitation method. TM (transition metal) sulphate solution (Ni:Co:Mn=0.9:0.05:0.05 in molar ratio, 2 mol L⁻¹) was fed into a tank containing a solution of NaOH and NH₃·H₂O with a PH of 12. The pH value was maintained at 12 during the co-precipitation process by adjusting the feeding rate of NH₃·H₂O (5 g L⁻¹). The reaction temperature was set at 50° C. for 40 h with the protection of N₂ atmosphere. The synthesized Ni_{0.9}Co_{0.05}Mn_{0.05}(OH)₂ precursor was obtained by filtering and washing with deionized water and drying at 110° C. for 8 h. Then NCM90 was synthesized by mixing LiOH·H₂O and Ni_{0.9}Co_{0.05}Mn_{0.05}(OH)₂ with a molar ratio of 1.05:1 between the lithium and transition metals. The mixture was then calcinated at 740° C. for 10 h with a heating rate of 2° C. min⁻¹ under an atmosphere of oxygen.

### Example 2. Synthesis of NCM90 with ZrO₂ Coating Only

2000 ppm ZrO₂ nanoparticles (about 100 nm) was added into the mixture of Ni_{0.9}Co_{0.05}Mn_{0.05}(OH)₂ precursor and LiOH·H₂O, which was pre-mixed with a molar ratio of 1.05:1 between the lithium and the transition metals. And then the whole mixture was further calcinated at 740° C. for 10 h under oxygen atmosphere with a heating rate of 2° C. min⁻¹.

### Example 3. Synthesis of NCM90 with High-Entropy Metal Oxide Coating

2000 ppm ZrO₂ nanoparticles (about 100 nm) and 1000 ppm Nb₁₂WO₃₃ nanoparticles (about 100 nm) were added into the mixture of Ni_{0.9}Co_{0.05}Mn_{0.05}(OH)₂ precursor and LiOH·H₂O, which was pre-mixed with a molar ratio of 1.05:1 between the lithium and the transition metals. And then the whole mixture was further calcinated at 740° C. for 10 h under oxygen atmosphere with a heating rate of 2° C. min⁻¹. During calcination, the homogenously mixed ZrO₂, Nb₁₂WO₃₃, Ni_{0.9}Co_{0.05}Mn_{0.05}(OH)₂ and LiOH·H₂O reacted to form NiCoMnNbZrWOₓ-coated NCM90 cathode.

### Example 4. Morphology and Structures of NiCoMnNbZrWOₓ-Coated NCM90

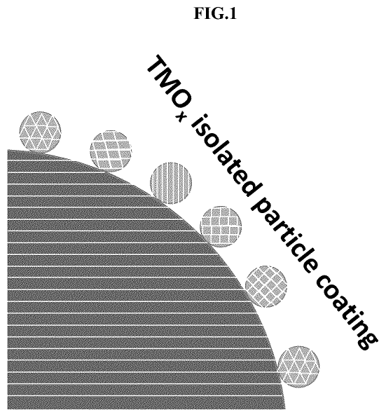

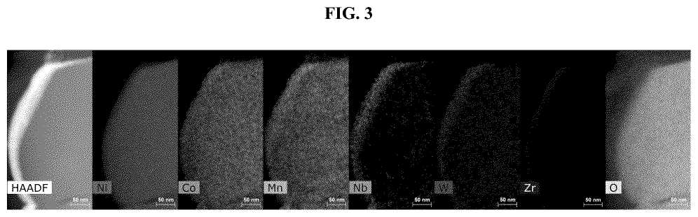

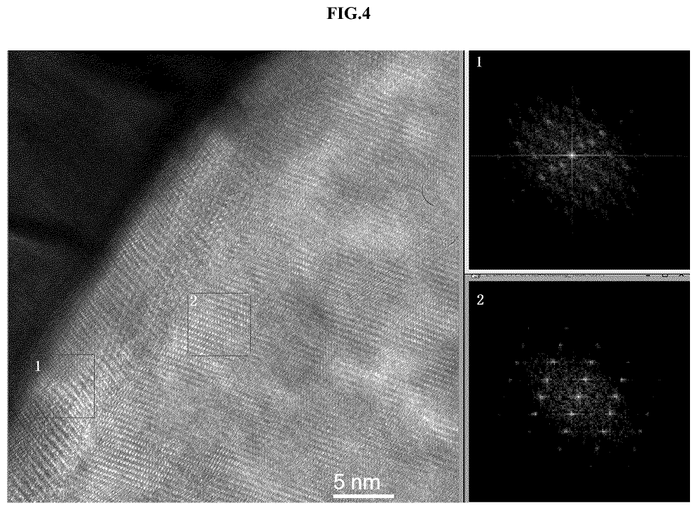

To confirm the formation of high-entropy metal oxide coating layer on the surface of NCM90, high-angle annular dark-field scanning transmission electron microscopy (HAADF-STEM) elemental mapping was conducted to reveal the distribution of Ni, Co, Mn, Zr, Nb, W and O throughout the NCM90 particle. As shown in FIG. 3, a layer comprising Ni, Co, Mn, Zr, Nb, and W with a thickness of about 5 nm was formed on the surface of NCM90 particle. Unlike the results in the individual TMOₓ coating particles which usually exhibit separated islands (e.g., FIG. 1), the elemental mapping results in the case of high-entropy metal oxide coating was continuous, indicating they were formed in a single phase. To verify that, high-resolution transmission electron microscopy was conducted, which can display the lattice fringe of coating layers. FIG. 4 clearly shows the formation of a continuous lattice fringe on the surface of layered NCM90, rather than separated particles with different orientation. The selected area electron diffraction (SAED) of the marked areas in FIG. 4 further revealed the crystal structure of the coating layer and the bulk cathode, respectively. The SAED in marked area 1 of FIG. 4 exhibits single diffraction pattern of coating layer, confirming its single-phase structure. The SAED in marked area 2 of FIG. 4 confirms the layered structure of NCM90 cathode.

### Example 5. Illustrative Batteries Using NCM90 Cathode Materials with Various Coatings

Separately, 80 wt. % of the NCM90 material prepared according to Example 1 (also referred to as “bare NCM90”), Example 2 (also referred to as “NCM with ZrO₂”), or Example 3 (also referred to as “NCM with high-entropy coating”) were mixed with 10 wt. % Super-P and 10 wt. % PVDF (formed from 8 wt. % PVDF in NMP (N-methylpyrrolidone)) binder. The well-mixed slurry was then cast onto a sheet of aluminum foil by a doctor blade on an automatic film coater. The film was dried in a vacuum oven at 80° C. for 12 h and then transferred to a glove box filled with argon, before being punched out as circular, 14 mm in diameter, disks. The electrolyte for the cells was 1.2 M LiPF₆ salt in ethyl carbonate (EC) and Ethyl methyl carbonate (EMC) with a volume ratio of 3:7. A CR2032 coin cell was then assembled using the prepared electrode disk, the prepared electrolyte, a lithium foil counter electrode, and a separator. Cell assembly was conducted in a glove box filled with argon.

### Example 6. Electrochemical Properties of the Cells from Example 5

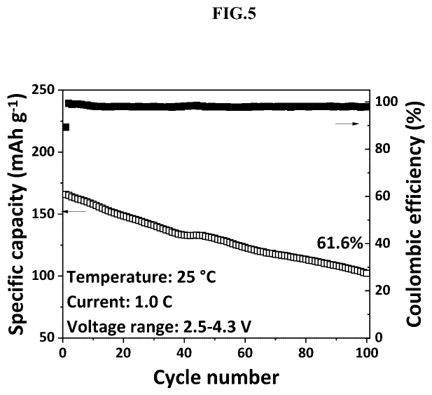

The assembled coin cells were subject to charge/discharge cycles within a relatively wide voltage range of 2.5 V to 4.3 V. FIG. 5 shows the cycling stability of bare NCM90 cathode during cycling at a charge/discharge rate of 1 C (200 mA g⁻¹) after formation at 0.1 C for the first three cycles. The bare NCM90 without any coatings exhibited an initial discharge specific capacity of 165.8 mAh/g with continuous capacity degradation. After 100 cycles of charge/discharge, it only maintained a reversible capacity of about 102.2 mAh g⁻¹, leading to a poor capacity retention of 61.6%. These results are consistent with the intrinsic poor structure stability of bare NCM90 during cycling.

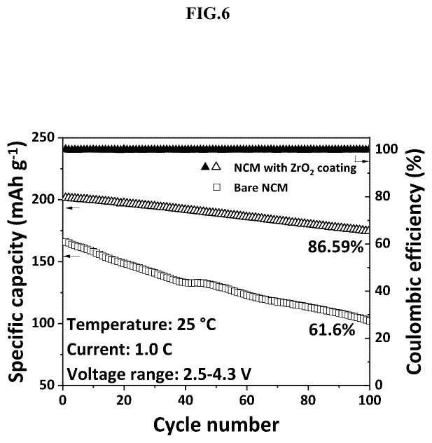

With ZrO₂ particles coating, the cycling stability of NCM 90 cathode was improved. As shown in FIG. 6, the NCM 90 with ZrO₂ coating not only exhibited higher specific capacity throughout 100 cycles of charge/discharge, but also demonstrated better capacity retention of 86.59% than bare NCM90. The results indicate that ZrO₂ coating can help to suppress the reactions of charged NCM90 with the electrolytes. However, visible degradation was still observed due to the uneven coating of ZrO₂ particles on the surface of NCM90, leading to formation of un-protected NCM90 spots.

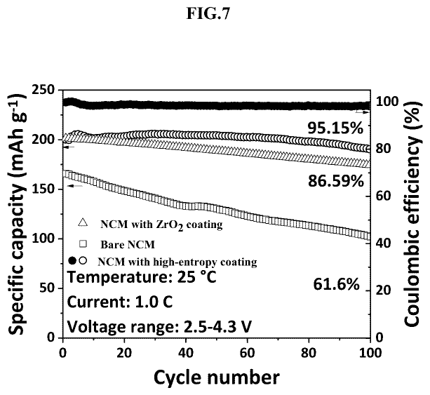

The high-entropy NiCoMnNbZrWOₓ coating can provide a better coating uniformality and hence a comprehensive protection. As shown in FIG. 7, the NCM90 with high-entropy coating demonstrated a high specific capacity of about 200 mAh g⁻¹ and a superior cycling stability. After 100 cycles, the capacity retention was as high as 95.15%, superior to both bare and ZrO₂ coated one. These results confirm that the high-entropy coating is advantageous in protecting NCM90 cathode from undesired side reactions and capacity loss during charge/discharge.

Fast charging is important to the application of batteries. It means the battery needs to be charged/discharged in a much shorter time to full capacity. When translating the above requirements to battery testing, it means it is needed to evaluate the specific capacity and cycling stability of the cathode materials at a much higher charge/discharge rate, for example, at 5 C (equal to 12 minutes for charge or discharge).

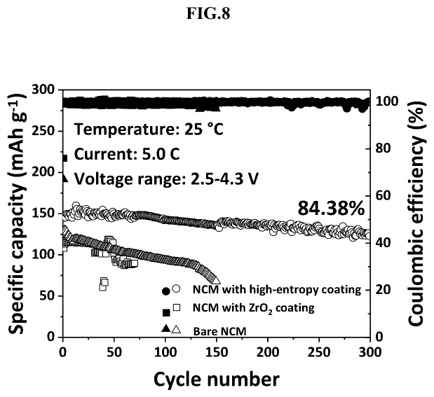

FIG. 8 compares the cycling stability of bare NCM 90, as well as NCM 90 with ZrO₂ coating and high-entropy coating at 5 C. As clearly shown in FIG. 8, both bare NCM90 and the ZrO₂ coated NCM 90 exhibited lower specific capacity and much faster capacity degradation compared to the NCM90 with high-entropy coating. By sharp contrast, the high-entropy coated NCM90 could still demonstrate a good capacity retention of 84.38% after 300 cycles at an extreme high charge/discharge rate of 5 C, confirming that the high-entropy coating layer is advantageous in facilitating ionic transport and suppressing mechanical cracking.

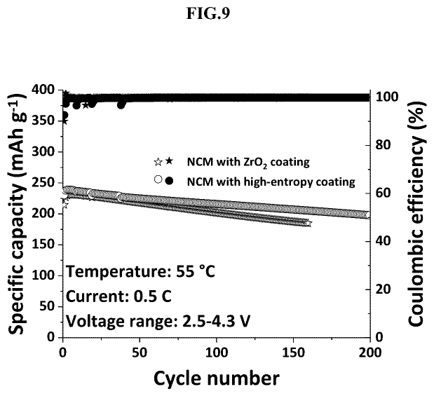

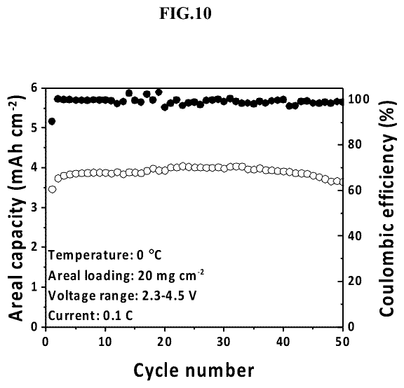

Wide temperature range is another critical factor for battery application to accommodate the global and regional temperature difference. Further test was conducted to compare the cycling stability of NCM cathode with ZrO₂ coating and NCM cathode with high-entropy coating, at an elevated temperature of 55° C. and a charge/discharge rate of 0.5 C. As shown in FIG. 9, the high-entropy coating exhibited better cycling stability than ZrO₂ coating. In addition, FIG. 10 shows the cycling stability of high entropy coated NCM90 cathode at a temperature of 0° C. and charge/discharge rate of 0.1 C with a very high mass loading of 20 mg cm⁻² that is close to commercial battery level. The results show that even at low temperature, the high entropy coated one could still demonstrate stable cycle.

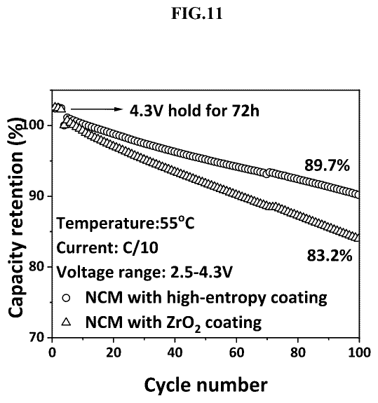

In addition to cycle life, shelf life is also important for battery application. Battery shelf life is the length of time a battery can remains in storage without losing its capacity. Even when not in use, batteries age. The battery's aging is generally affected by three factors: state of charge (SoC), the storage temperature and the length of time it remains idle. During storage, batteries self-discharge and their contents are prone to decomposition. Higher temperatures make battery self-discharge faster, and cooler temperatures decrease the self-discharge rate. Electrolyte, a chemical in batteries containing high concentration of ions, may permeate through the seals. This causes the battery to dry up and become unusable. Tests were conducted to compare the calendar aging effect of NCM90 cathode with ZrO₂ coating and high-entropy coating during storage at 55° C. and a high state of charge of about 80% (by using constant voltage charging at 4.3 V) for 72 h. FIG. 11 shows that the high-entropy coating exhibits better protection for NCM90 cathode during calendar aging.

### Example 7. Illustrative Batteries Using High-Entropy Metal Oxides Coated NCM90 Cathode Material and Graphite Anode in Lithium-Ion Batteries

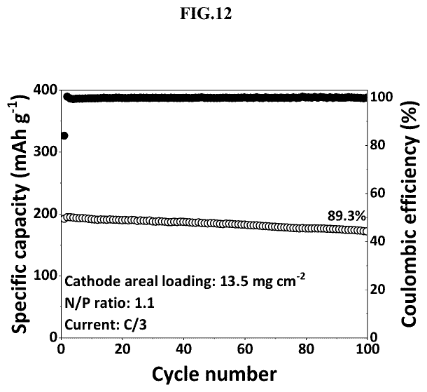

A CR2032 coin cell was assembled using the prepared cathode disk of Example 5, the prepared electrolyte of Example 5, a graphite electrode as anode, and a separator. Cell assembly was conducted in a glove box filled with argon. The cathode loading is controlled at 13.5 mg cm⁻², and the capacity ratio between negative electrode and positive electrode is 1.1. The cell was charge/discharged at C/3 within 2.8-4.3 V. FIG. 12 shows that the high-entropy coated cathode could demonstrate a good cycling stability when coupled with commercial graphite anode in lithium-ion batteries.

### Example 8. Illustrative Batteries Using High-Entropy Metal Oxides Coated NCM90 Cathode Material and Lithium Metal Anode in Pouch Cell Type Lithium Metal Batteries

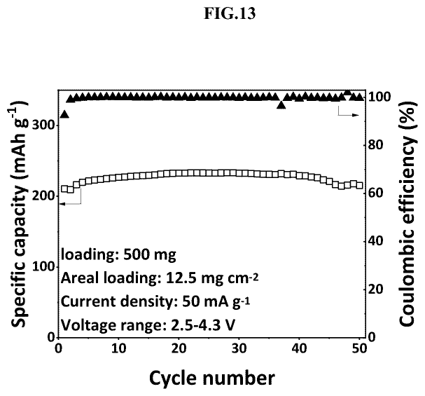

Lithium metal batteries using lithium metal as anode demonstrate higher energy density than conventional lithium-ion batteries. However, they tend to degrade quickly due to the degradation of lithium metal, such as dendrite. Recently, cathode crossover due to the dissolution and migration of cathode species has shown significant impact on the stability of lithium metal anode. Moreover, it is essential to evaluate the performance of battery materials in practical pouch cell configuration. Tests were performed to examine the cycling performance of a single-layer pouch cell using Li metal anode and high-entropy coated NCM90 cathode with a dimension of 5 cm×8 cm. The total mass of the cathode was 500 mg, leading to an area loading of 12.5 mg cm⁻². The cell was charge/discharged at 50 mA g⁻¹ within 2.5-4.3 V. The results are illustrated in FIG. 13. It was found that the assembled lithium metal pouch cell with high entropy coated NCM90 cathode demonstrated both high specific capacity and stable cycle life, indicating that high entropy metal oxide coating could benefit the performance of cathode materials in high-energy lithium metal batteries.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation, or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrode for an electrochemical device, comprising:
an electroactive material comprising a surface;
a primary coating layer on the surface of the electroactive material, the primary coating layer comprising a high entropy metal oxide (HEO); and
optionally a secondary coating layer comprising an ionic and electronic conductive polymer;
wherein the secondary coating layer when present is disposed directly on the surface of the electroactive material, on the primary coating layer, or both directly on the surface of the electroactive material and on the primary coating layer.

2. The electrode of claim 1, wherein the HEO comprises
at least five constituent cations selected from the group consisting of Li, Ni, Co, Mn, Nb, W, Zr, La, Al, Ti, Cu, Si, Mg, Zn, Sn, Ta, Fe, Sb, Y, Cr, Mo, V, and Sc cations;
at least five constituent cations selected from the group consisting of Ni, Co, Mn, Nb, W, Zr, La, Al, Ti, Cu, Si, Mg, Zn, Sn, Ta, Fe, Sb, Y, Cr, Mo, V, and Sc cations;
at least five constituent metal cations selected from the group consisting of Ni, Co, Mn, Nb, W, Zr, La, Al, Ti, and Ta cations;
at least five constituent metal cations selected from the group consisting of Ni, Co, Mn, Nb, W, Zr, Al, Ti, and Ta cations; or
at least five constituent metal cations selected from the group consisting of Ni, Co, Mn, Nb, W, and Zr cations; and
wherein the cations are present with different weight percentages.

3. The electrode of claim 1, wherein the primary coating layer is present in a weight percentage from >0 wt. % to about 5 wt. %, based on the weight of the electroactive material; and the primary coating has a thickness from about 0.5 nm to about 30 nm.

4. The electrode of claim 1, wherein the primary coating layer comprises aligned diffusion channels for alkaline ions.

5. The electrode of claim 1, wherein the ionic and electronic conductive polymer comprises poly(3,4-ethylenedioxythiophene), polypyrrole, polyaniline, or a blend of any two or more thereof.

6. The electrode of claim 1, wherein the secondary coating layer is present in a weight percentage from 0 wt. % to about 3 wt. %, based on the weight of the electroactive material; and the secondary coating has a thickness from about 0.5 nm to about 20 nm.

7. The electrode of claim 1, wherein the electroactive material comprises: layered lithium nickel manganese cobalt oxide (Li_{1+δ}NiₓMn_{y}Co_{z}O₂, δ≥0, x+y+z=1); layered lithium nickel cobalt aluminum oxide (LiNiₓCo_{y}Al_{z}O₂, x+y+z=1); LiCoO₂; LiNiO₂; LiMnO₂; lithium cobalt oxide (LiCoO₂); spinel lithium nickel manganese oxide (LiNiₓMn₂₋ₓO₄, 0≤x≤2); lithium iron phosphate (LiFePO₄); LiNiPO₄; LiMnₓFe₁₋ₓPO₄ (0≤x≤1); LiCoPO₄; layered sodium transition metal oxide (NaTMO₂); or a mixture of any two or more thereof, wherein TM is Fe, Co, Ni, Mn, Cr, V, Cu, Ti, or a combination of any two or more thereof.

8. The electrode of claim 7, wherein the electroactive material further comprises dopants selected from the group consisting of Sn, Al, Ti, La, Mg, Zn, Si, Ta, Mo, W, Nb, Fe, Cu, Cr, and Zr.

9. The electrode of claim 7, wherein the electroactive material is in a form of polycrystalline particles that are micrometer-sized spherical secondary particles comprising nanometer-sized primary particles, or
the electroactive material is in a form of single-crystalline particles that do not contain primary particles.

10. An energy storage device, comprising a cathode comprising the electrode of claim 1, an anode, a separator, and an electrolyte.

11. The energy storage device of claim 10, wherein the anode comprises lithium metal, sodium metal, graphite, hard carbon, silicon, tin, antimony, phosphorus, transition metal oxide lithium titanate, or a combination of any two or more thereof.

12. The energy storage device of claim 10, wherein the cathode and/or the anode comprise one or more of
a current collector;
a conductive carbon material; and
a binder that is sodium carboxymethylcellulose, sodium alginate, poly(acrylic acid), lithiated poly(acrylic acid), sodiated poly(acrylic acid), poly (vinyl alcohol), polyvinyl acetate, poly (ethylene imine), carboxymethyl chitosan, glutaradehyde, B-cyclodextrin polymer, Gum Arabic, PEDOT-PSS, polyacrylic latex, gelatin, polyamido amine, polyvinylidene fluoride, polytetrafluoroethylene, polyethylene, polystyrene, polyethylene oxide, polyimide, styrene butadiene rubber (SBR), polythiophene, polyacetylene, poly(9,9-dioctylfluorene-co-fluorenone), poly(9,9-dioctylfluorene-co-fluorenone-co-methylbenzoic ester), or a combination of any two or more thereof.

13. The energy storage device of claim 10, wherein
a. the electrolyte comprises a salt and a solvent comprising ethylene carbonate, propylene carbonate, diethyl carbonate, dimethyl carbonate, ethyl methyl carbonate, tetraethylene glycol, dimethylsulfolane, 1,2-dimethoxyethane, 1,2-diethoxyethane, or a combination of any two or more thereof, or
b. the electrolyte is a solid electrolyte that is a ceramic electrolyte, a polymer electrolyte, a glass electrolyte, or a combination of any two or more thereof.

14. A method of making an electrode for an energy storage device, comprising:
applying a primary coating layer comprising a high entropy metal oxide (HEO) over an electroactive material;
optionally applying a secondary coating layer comprising a polymer; and
wherein
the secondary coating layer is disposed directly on the surface of the electroactive material, on the primary coating layer, or both directly on the surface of the electroactive material and on the primary coating layer.

15. The method of claim 14, wherein the HEO comprises at least five constituent cations selected from the group consisting of Li, Ni, Co, Mn, Nb, W, Zr, La, Al, Ti, Cu, Si, Mg, Zn, Sn, Ta, Fe, Sb, Y, Cr, Mo, V and Sc cations; and wherein the cations are present with different weight percentages.

16. The method of claim 14, wherein the primary coating layer is formed via a solid-state reaction comprising:
mixing nanoparticles of various metal oxides and the electroactive material to form a mixture; and
calcinating the mixture for about 10 h to 20 h at a temperature of about 700° C. to about 900° C.

17. The method of claim 16, wherein the nanoparticles have a particle size of less than 200 nm.

18. The method of claim 14, wherein the secondary coating layer is formed via a gas-phase polymerization between monomers, and wherein the polymerization is conducted at a temperature of about 60° C. to about 150° C. and under a pressure of about 0.1 torr to 1.0 torr.

19. The method of claim 14, wherein the monomers comprise 3,4-ethylenedioxythiophene, pyrrole, or aniline.

20. The method of claim 14, wherein the gas-phase polymerization is conducted in the presence of an oxidant selected from VOCl₃ and SbOCl₃.
